(19) United States
(12) Patent Application Publication
(10) Pub. No.: US 2016/0104214 A1
(43) Pub. Date: Apr. 14, 2016

(54) Vehicle Appraisal System

(71) Applicant: ZTrack360, Inc., Las Vegas, NV (US)

(72) Inventors: Steven E. Larrinaga, Alta Loma, CA (US); Derek A. Perez, Dublin, CA (US)

(73) Assignee: ZTRACK360, INC., Las Vegas, NV (US)

(21) Appl. No.: 14/802,723

(22) Filed: Jul. 17, 2015

Related U.S. Application Data
(63) Continuation-in-part of application No. 14/510,682, filed on Oct. 9, 2014.

(51) Int. Cl. G06Q 30/02

(52) U.S. Cl. CPC G06Q 30/0278

(57) ABSTRACT

A system for a sales associate to create a vehicle trade in value report, including a data communication network, a management console in communication with the data communication network, and a mobile console in communication with the data communication network. The mobile console includes a user interface for receiving input from the sales associate, a display for presenting information to the sales associate, a wireless communication interface for sending information to and receiving information from the data communication network, a data reader, a memory for storing the information that is sent and received and for storing operational instructions for the mobile console, and a processor for controlling and for sending information to and receiving information from the user interface, the display, the wireless communication interface, the data reader, and the memory. At least one of the processor and memory include programming for receiving through the data reader information in regard to a vehicle identification number (VIN) of the vehicle, and storing it with vehicle data, receiving through the user interface information in regard to condition of the vehicle, and storing it with the vehicle data, sending the vehicle data from the mobile console across the data communication network to the management console, receiving from the management console across the data communication network at the mobile console the vehicle trade in value report, and displaying the report on the display.

This application claims rights and priority on prior pending U.S. patent application Ser. No. 14/510,682 filed 2014 Oct. 9. This invention relates to the field of sales management. More particularly, this invention relates to providing a vehicle appraisal report to a customer.

### FIELD

### Introduction

Having accurate and timely information is often a critically important part of business management. This general principle applies to the management of a sales force, such as a sales force consisting of one or more sales managers and one or more sales associates. Such a sales force can be found in many different settings, such as a retail store, vehicle dealership, or crowd vendors in a sporting venue.

In the past, it has been labor-intensive for the sales manager to know which associates have arrived at the place of business, when they arrived, if they are currently helping a customer, the progress that they are making with the customer, whether they have left the place of business (and for what purpose), and so forth.

What is needed, therefore, is a system that reduces problems such as those described above, at least in part.

### SUMMARY

The above and other needs are met by a system for a sales associate to create a vehicle trade in value report, including a data communication network, a management console in communication with the data communication network, and a mobile console in communication with the data communication network. The mobile console includes a user interface for receiving input from the sales associate, a display for presenting information to the sales associate, a wireless communication interface for sending information to and receiving information from the data communication network, a data reader, a memory for storing the information that is sent and received and for storing operational instructions for the mobile console, and a processor for controlling and for sending information to and receiving information from the user interface, the display, the wireless communication interface, the data reader, and the memory. At least one of the processor and memory include programming for receiving through the data reader information in regard to a vehicle identification number (VIN) of the vehicle, and storing it with vehicle data, receiving through the user interface information in regard to condition of the vehicle, and storing it with the vehicle data, sending the vehicle data from the mobile console across the data communication network to the management console, receiving from the management console across the data communication network at the mobile console the vehicle trade in value report, and displaying the report on the display.

In some embodiments according to this aspect of the invention, the mobile console is a smart phone or a tablet computer. In some embodiments, the data communication network is at least one of a wireless data network and a cellular data network. In some embodiments, the vehicle data further comprises at least one of vehicle mileage, vehicle body damage, vehicle glass damage, vehicle paint damage, vehicle interior damage, vehicle location. In some embodiments, the user interface is at least one of a touch-screen, a voice recognition module, and a keyboard.

According to another aspect of the invention there is described a method for creating a vehicle trade in value report, wherein there is provided a data communication network, a management console in communication with the data communication network, and a mobile console in communication with the data communication network. The mobile console includes a user interface for receiving input, a display for presenting information, a wireless communication interface for sending information to and receiving information from the data communication network, a data reader, a memory for storing the information that is sent and received and for storing operational instructions for the mobile console, and a processor for controlling and for sending information to and receiving information from the user interface, the display, the wireless communication interface, the data reader, and the memory.

Information is received through the data reader in regard to a vehicle identification number (VIN) of the vehicle, and stored with vehicle data. Information is also received through the user interface in regard to condition of the vehicle, and stored with the vehicle data. The vehicle data is sent from the mobile console across the data communication network to the management console. The mobile console receives across the data communication network from the management console the vehicle trade in value report, which is displayed on the display.

In some embodiments according to this aspect of the invention, the mobile console is smart phone or a tablet computer. In some embodiments, the data communication network is at least one of a wireless data network and a cellular data network. In some embodiments, the vehicle data further comprises at least one of vehicle mileage, vehicle body damage, vehicle glass damage, vehicle paint damage, vehicle interior damage, vehicle location.

### DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a functional block diagram of a sales force tracking and management system according to an embodiment of the present invention; and

FIG. 2 is a flow chart of a method of operating the sales force tracking and management system according to an embodiment of the present invention.

FIG. 3 is a flow chart of a method for generating a vehicle trade in value report according to an embodiment of the present invention.

### DESCRIPTION

With reference now to the figures, there are described various embodiments of the present invention. Although these embodiments are generally applicable to a wide variety of sales environments, the particular example of vehicle sales at a vehicle dealership is used as the primary example below.

### Apparatus

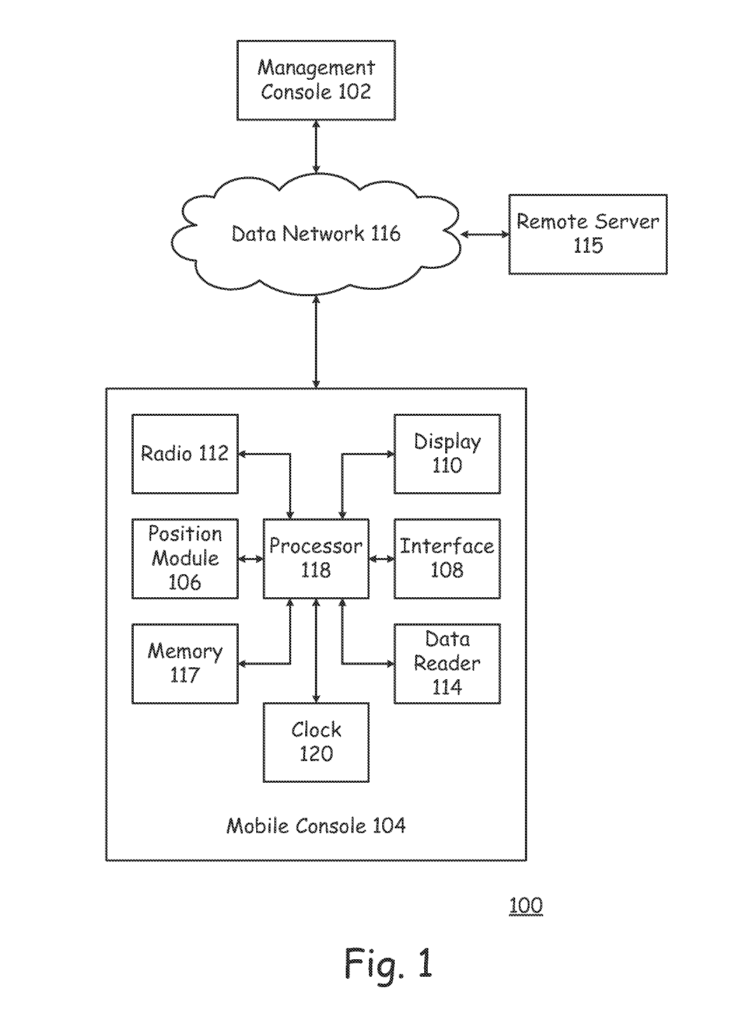

FIG. 1 depicts a functional block diagram of the sales force tracking and management system 100 according to one embodiment of the present invention. In this embodiment, a management console 102 is in communication with a data network 116, which is in communication with a mobile console 104. The management console 102 can take a variety of different forms, but in one embodiment is a computing platform such as a personal computer or laptop computer. In other embodiments, the management console 102 is a mobile computing platform, such as a smart phone or a tablet computer.

In some embodiments the mobile console 104 is a mobile computing platform, such as a smart phone or a tablet computer. In other embodiments, the mobile console 104 is a dedicated hardware device that is built specifically for the functions and purposes described herein, and having the hardware components as described herein. In some embodiments the mobile console 104 is a smart watch. In some embodiments, the mobile console 104 is a laptop computer or a desktop personal computer.

The data network 116 is, in some embodiments, a global network such as the Internet. In other embodiments, the data network 116 is a private local network. Other data networks are also contemplated. In some embodiments, the data network 116 includes a wireless network, such as a cellular data network. In some embodiments, the data network 116 is combination of networks, such as an IEEE 802.3 Ethernet network connected to the Internet, a cellular network such as IEEE 802.16, or a local wireless network such as an IEEE 802.11a/b/g/n network, for example.

In some embodiments of the invention, some or all of the processing tasks described herein are performed on a cloud-based remote server 115 that is in communication with the management console 102 and the mobile console 104 via the data network 116. In these embodiments, the management console 102 and the mobile console 104 pass data back and forth to the remote server using dedicated software applications loaded on the management console 102 and mobile console 104 or via web browser applications on the management console 102 and mobile console 104.

The management console 102, data network 116, and mobile console 104 are configured to have the capability for the management console 102 and the mobile console 104 to send messages and other data back and forth one to another. Some of these messages and data are automatically sent and received, in that they are initiated by the sending device upon the occurrence of one or more predetermined events and received by the receiving device without the user thereof making a request for any such information. Others of these messages and data are manually sent and received, in that at least one of the users of the sending and receiving devices makes a request for such information to either be sent or received, as described in more detail below.

In some embodiments, the mobile console 104 includes the hardware modules as depicted in FIG. 1 and generally described below. A wireless communication interface 112 is used to wirelessly communicate with the data network 116. In this regard, the term “wireless communication interface” is used in a generic sense, and not by way of limitation, to indicate a circuit that generally converts a data signal received on a wire into a broadcast signal, such as a terrestrial broadcast signal, and vice versa. In various embodiments, the wireless communication interface 112 is capable of communicating with one or more of the data networks 116 as described above.

A display 110 presents information to the user of the mobile console 104, such as the messages that are sent and received, and other information and data. In some embodiments the display 110 is a graphics-based color display, such as an LED/LCD screen or an AMOLED display. A user interface 108 accepts input from the user of the mobile console 104, such as manually entered messages and control instructions for the mobile console 104. In some embodiments the interface 108 is a keyboard, and in some embodiments the interface 108 is a touchscreen comprising a touch-sensitive or proximity-sensitive layer integrated into the display 110.

In some embodiments the mobile console 104 includes a data reader 114, which is an alternate means for inputting data to the mobile console 104. For example, in some embodiments that data reader 114 is a laser bar code scanner. In other embodiments, the data reader 114 is a sensor such as a camera that can capture either still images or video. In some embodiments the data reader 114 works in conjunction with a processor 118 to convert information that is captured in a visual format into electronic data, such as by using optical character recognition (OCR) to convert graphically captured text characters into ASCII characters (or some other digital data standard) or converting optically captured bar codes into one or more digital data standards. In some embodiments that data reader 114 includes capabilities such as facial recognition and biometric input. In some embodiments, the data reader 114 is an RFID tag reader.

Some embodiments of the present invention include a position module 106. In some embodiments the position module 106 is a GPS module. In other embodiments the position module 106 detects some other type of terrestrial based signal, such as a cellular signal, and uses information in conjunction with that signal to determine the geographical position of the mobile console 104, such as by one or more of signal strength, triangulation, or some other method.

A memory 117 provides storage for messages and data that is either captured by, input to, or received by one or more of the wireless communication interface 112, the user interface 108, and the data reader 114 of the mobile console 104. In some embodiments the memory 117 also provides storage for command and programming information that is used by the processor 118 to control the operation of the mobile console 104.

Some embodiments of the mobile console 104 also include a clock 120. In some embodiments the clock 120 includes the capability to receive a time signal, such as through the wireless communication interface 112, so the clock 120 can be accurately maintained, either automatically or upon the input of a command by the user of the mobile console 104 to update the clock 120. In some embodiments the clock 120 contains circuitry to maintain the time when an external time confirmation source is not available.

The management console 102, data network 116, and mobile console 104 work in conjunction one with another to implement the functions and general operation of the sales management system as described herein.

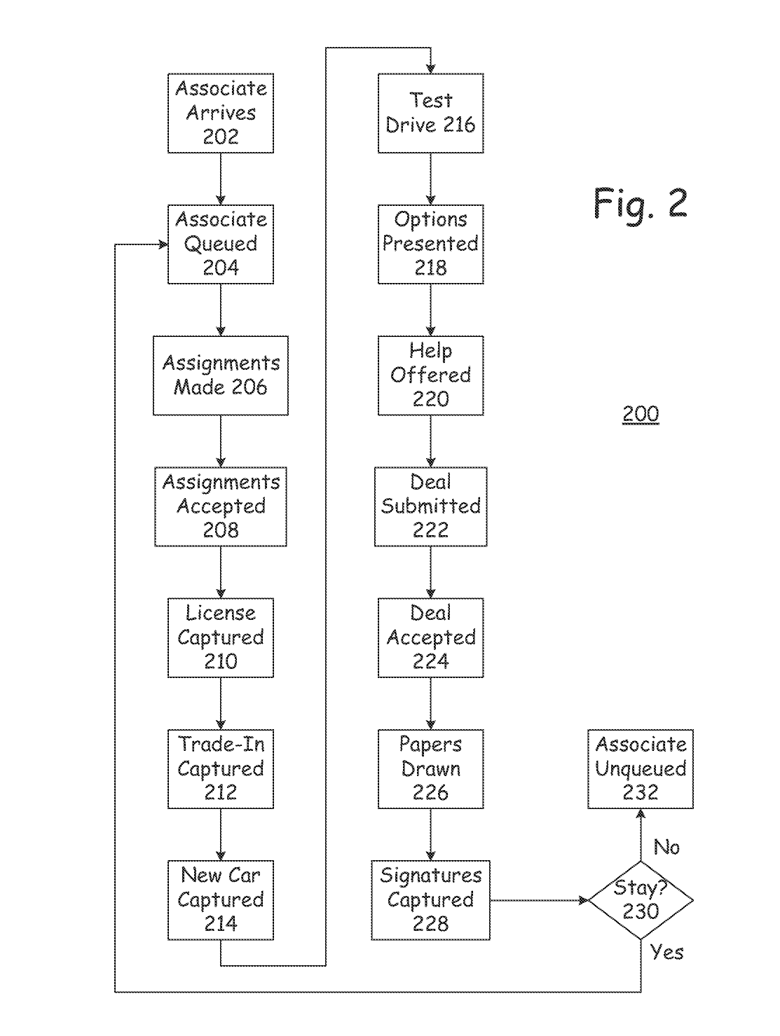

With reference now to FIG. 2, there is depicted a simplified flow-chart 200 for the operation of a preferred embodiment of the sales force tracking and management system 100. It is appreciated that the order of these steps in all embodiments is not necessarily the same as that as given in the embodiment depicted in FIG. 2. In this embodiment, the system 100 is activated when sales associates arrive at the sales venue, carrying their mobile consoles 104 (step 202). The position module 106 reports the position of the mobile console 104, and thereby the position of the associate, as the associate enters the sales venue, such as a vehicle dealership. One or more of the management console 102 and the mobile console 106 checks the position of the mobile console 104 relative to a predefined geographical boundary, such as the boundaries of the vehicle dealership (to continue the present example), and a report is thereby made from the mobile console 104 to the management console 102 that the associate has arrived at the sales venue. In some embodiments a time stamp, such as from the clock 120, is associated with the report that is generated.

In one embodiment, the management console 102 builds a queue of the associates who have arrived at the sales venue (step 204). In some embodiments, those associates who arrive earliest, such as based on the time stamp described above, are given higher priority in the queue that is built, and they are the associates assigned to the first customers that arrive (step 206). Thus, the sales system 100 keeps track of the associates in this manner, and is aware of which associates are available to help customers.

When an associate is up in the queue to receive a customer, the management console 102 pushes a notification to that associate's mobile console 104. In one embodiment, this is an automated message from the management console 102 to the mobile console 104, in that the system 100 identifies that the associate is on the sales lot, identifies a customer waiting for service, identifies the next associate in the queue, and pushes out the assignment message to the appropriate mobile console 106 without any other intervention by either the sales associate or the sales manager.

In one embodiment, the associate manually sends a message from the mobile console 104 to the management console 102 indicating that the associate has received the assignment and accepted it (step 208). While this can be accomplished in a number of different ways, in one embodiment the associate merely presses an acknowledgement button that appears on the display 110 of the mobile console 104 when the assignment message is received, and the simple press of the button (either a software button or a hardware button, for example) is sufficient to send the acceptance message back to the management console 102.

In the embodiment in which the system 100 is used for the management of a vehicle dealership, there is a variety of information that is typically gathered from the customer. For example, if the customer is interested in a test drive of a new vehicle, then the customer might need a valid driver's license. In one embodiment, the associate uses the data reader 114 on the mobile console 104 to read the bar code on the customer's driver's license, thereby capturing the relevant data therefrom, and the mobile console 104 transmits the information to the management console 102, where the information is kept on file as needed (step 210). In some embodiments, the data reader 114 optically scans the text-based information on the driver's license, recognizes the text, and sends that information to the management console 102. In some embodiments, the data reader 114 captures an image of the driver's license and sends the image to the management console 102 for any further processing as desired. In some embodiments, the information from the driver's license is compared to a database of such information that is accessible by the management console 102, to determine whether there are any issues involved with allowing the customer to take a test drive.

In some embodiments, if the customer desires to trade in their current vehicle, the associate uses the data reader 114 on the mobile console 104 to read the VIN of the vehicle that is to be traded in (step 212). The VIN information can be captured in a variety of different ways, such as those described above. In some embodiments the mobile console 104 captures the VIN information and provides a form for the associate to fill out to capture the other information about the vehicle that is needed to determine a trade in value, such as the mileage, general condition, outstanding balance, and so forth.

In some embodiments, the customer is involved in the data entry process, so that the customer can see beforehand the information upon which the estimate will be based and receive explanations about how that information effects the trade in value of the vehicle. In this manner, the customer is better prepared to receive a realistic trade in estimate, and does not expect to receive the full value as listed on websites such as KBB.com or Edmunds.com.

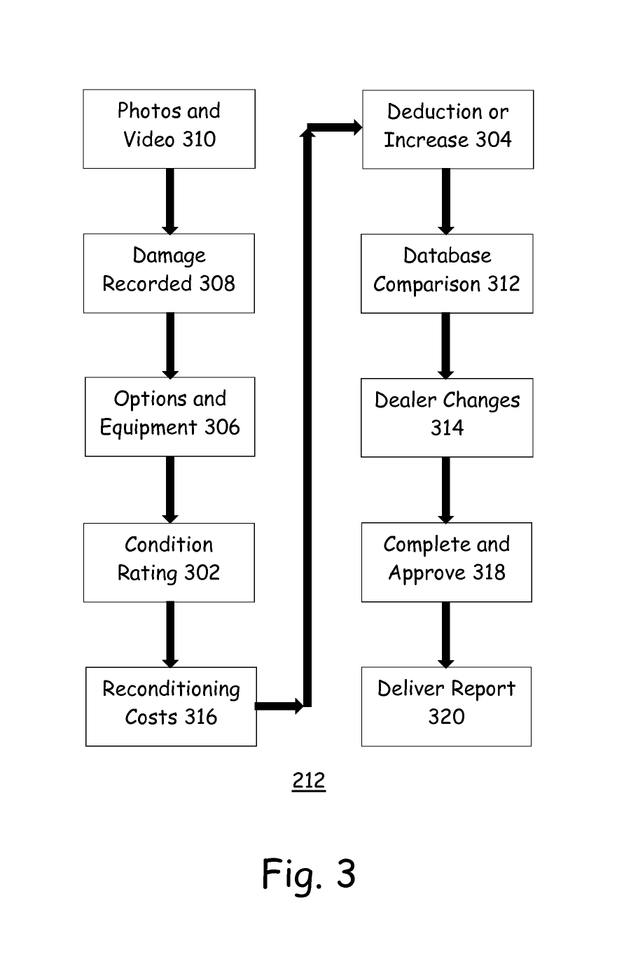

These embodiments are generally described in reference to FIG. 3, which is an expanded view of the step embodied in block 212 of FIG. 2. FIG. 3 as depicted provides one embodiment for the order of the steps for producing the report. However, other orders are also described and contemplated herein.

For example, the associate can discuss the vehicle condition with the customer, and use the mobile console 104 to select the appropriate condition using the KBB rating system of very good, good, and fair, etc., as given in block 302. Each option is accompanied by an on-screen definition, so that the customer can see why a given option is to be selected for the condition of the vehicle.

Some embodiments include an option to enter a deduction or increase in value of the trade in, based upon criteria that might not be specifically encoded into the system, but which can be discussed with the customer prior to submitting the valuation data and issuing the trade in report, as given in block 304. Some embodiments also allow entry of various vehicle options and equipment that effect the value of the vehicle, as given in block 306.

Some embodiment include a physical damage selector that enables entry of the location and type of damage on the trade in vehicle, if any, as given in block 308. For example, the associate can select from a drop down menu of options the location of the damage, such as the right rear of the vehicle. Then the associate can select from a drop down menu the type of damage that is present in that location, such as paint damage, scratch, dent, ding, and so forth, and the severity of such. Some embodiments include an option in the programming of the mobile console 104 to capture and include photos and videos of the condition of the vehicle, such as damage, as given in block 310. In some embodiments, this information is compared to a database of industry standard costs to repair such damage, which costs are included in determining the final trade in value of the vehicle, as given in block 312. In other embodiments, the dealer is able to adjust the cost of repairs, as given in block 314.

Some embodiments include the optional inclusion of other reconditioning costs, such as dealership smog, safety, and detail costs, as given in block 316. In some embodiments, these costs are itemized on the mobile device 104, and the associate can discuss them with the customer. In some embodiments the amount of these costs are adjustable by the dealer, and in some embodiments the industry standards are preloaded and automatically used in the report.

In some embodiments, after all of the information has been entered and discussed by the associate and the customer, the final trade in value is determined by the manager, as given in block 318, before the report is delivered back to the associate and the customer, such as via the mobile platform 104, as given in block 320.

In one embodiment, the relevant information is transferred from the mobile console 104 to the management console 102, which acts as an interface to a database of used vehicle value information, such as KBB.com or Edmunds.com. The value of the trade in can then be automatically pushed out to the mobile console 104 from which the initial information was received, so that the associate can report to the customer the value of the trade in.

In some embodiments, the data reader 114 is also used to capture the VIN of the “new” vehicle that the customer is interested in buying (which is new to the customer, but may be a used vehicle) (step 214), and this information is transmitted by the mobile console 104 to the management console 102. This information can be used in a variety of different ways. For example, it can be used in a log of when the new vehicle is taken for test drives. It can also be used to identify potential conflicts, such as when more than one customer is interested in the same new vehicle. It can also be used to help put together a package offer to the customer, with a price that reflects the value of the new vehicle and the value of the customer's trade in.

In some embodiments, the functions as described above are provided in a web portal that is accessible by a customer computer. Instead of the sales associate describing the various entries made into the system, online descriptions are provided, which guide the customer through the process. These online descriptions can include text, graphics, photographs, audio, video, and audio or video conferencing. In this embodiment, the customer is able to receive a report on the trade in value of his vehicle without visiting the dealership. The dealership is sent referral information in regard to the customer.

In some embodiments the report includes elements other than just a value and related information, such as video and photographs of similar vehicles, or commentary in regard to deductions from or additions to the value of the vehicle.

In some embodiments that mobile console 104 has a button on the interface 108 or display 110 that the associate can push, indicating that the associate and the customer are going on a test drive. In one embodiment, this invokes the positioning module 106, and the route and duration of the test drive are logged by one or both of the management console 102 and the mobile console 104. If the information from the VIN of the new vehicle was recorded (step 214) and the driver's license information was recorded (step 210), then a complete record of the details of the test drive can be assembled and logged.

At some point during the sales presentation, such as after the test drive in some embodiments, the mobile console 104 can be used to present a variety of sales options to the customer (step 218). For example, the customer can be shown a comparison of the prices of the various cars of interest, with or without the value of the trade in included. In addition, cost of ownership can be included in the comparison, taking into account factors such as gas mileage, anticipated maintenance, insurance, and other relevant factors.

In some embodiments, if a deal is not submitted within a predetermined length of time, or upon the occurrence of some other event, then a push (automatic) notification of an offer to help with the sale is sent from the management console 102 to the mobile console 104 (step 220), such as by presenting an image of a button on the display 110 of the mobile console 104. In some embodiments, a secondary notification is also provided, such as by making a sound or causing the mobile console 104 to vibrate. If the sales associate would like assistance from the sales manager or another associate, then the associate can confirm this by merely pressing the button that is presented on the mobile console 104 which generates a confirmation message transmitted from the mobile console 104. Upon receipt of such a confirmation message, the management console 102 can notify another party, such as either the sales manager or another associate, to go the assistance of the sales associate, and can even provide the geographical location of the sales associate, in some embodiments.

The sales associate can use the mobile console 104 to submit a deal proposal through the management console to the sales manager (step 222). In response, the sales manager can send a message to the associate as to whether the deal is acceptable (step 224). If the deal is not accepted, then the sales manager can provide a counter offer through the management console 102 to the associate with the mobile console 104.

When the deal is acceptable to all parties, the management console 102 can produce the necessary documentation of the deal (step 226). In some embodiments the documentation is reduced to paper, while in other embodiments the relevant signatures can be captured on one or more of the management console 102 and the mobile console 104 (step 228). In a similar manner, the management console 102 or the mobile console 104 can be used, in some embodiments, to receive payment information, such as that required for a bank draft, or to apply for financing, process title, license, and registration paperwork, and so forth. Much of this can be accomplished by using the information that has already been gathered by the mobile console 104 during the initial sales process.

When the sale is concluded, the associate can indicate whether he/she is available for another customer (step 230). If the associate can take another customer, then the associate is returned to the queue (step 204) and the sales process is repeated. If the associate is no longer available, then the associate is removed from the queue (step 232).

In some embodiments, the mobile console 104 tracks when the sales associate leaves the predetermined geographical area of the sales venue, such as using one of the ways as described above, and sends a message of such to the management console 102. In some embodiments, this action of leaving the sales venue automatically takes the associate out of the queue. Also in the manner as indicated above, a time stamp can be associated with this information.

In some embodiments, the management console 102 presents a status display that provides a clear view of the current live activity at the sales venue, such as which associates are on the premises and their locations, which associates are with customers and at what point in the sales process they are, cars that are potential trade ins, cars that are being considered for purchase, route and duration of test drives, customer information, associate performance toward goals, and so forth.

In some embodiments, the mobile console 104 presents a status display that provides information to the associate, such as the length of time with the current customer, value of the trade in, acceptable base offer for the new vehicle, additional information in regard to the customer (such as found from a database), future appointments, messages from the sales manager, performance toward goals, and so forth.

In some embodiments the management console 102 keeps track of customers who have not made a purchase, and sends follow up sales and notice communications to such customers, such as via email or postal mail.

In some embodiments, the management console 102 pushes notifications to the mobile consoles 104 regarding cars on the sales lot that the sales manager has a heightened desire to sell. In this manner, the associates can be sure to show those cars to the customers. In some embodiments, the mobile console 104 presents a notification button on the display 110 of the mobile console 104 that the associate can press, sending a message to the management console 102 confirming that the associate has shown a given priority vehicle to his current customer.

In some embodiments, the management console 102 stores information regarding cars that a first customer has expressed an interest in, and indicates to the sales manager when a second customer arrives with a similar vehicle for potential trade in.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A system for a sales associate to create a vehicle trade in value report, the system comprising:
a data communication network;
a management console in communication with the data communication network; and
a mobile console in communication with the data communication network, the mobile console comprising:
a user interface for receiving input from the sales associate;
a display for presenting information to the sales associate;
a wireless communication interface for sending information to and receiving information from the data communication network;
a data reader;
a memory for storing the information that is sent and received and for storing operational instructions for the mobile console; and
a processor for controlling and for sending information to and receiving information from the user interface, the display, the wireless communication interface, the data reader, and the memory,
at least one of the processor and memory further comprising programming for:
receiving through the data reader information in regard to a vehicle identification number (VIN) of the vehicle, and storing it with vehicle data,
receiving through the user interface information in regard to condition of the vehicle, and storing it with the vehicle data,
sending the vehicle data from the mobile console across the data communication network to the management console,
receiving from the management console across the data communication network at the mobile console the vehicle trade in value report, and
displaying the report on the display.

2. The system of claim 1, wherein the mobile console is a smart phone or a tablet computer.

3. The system of claim 1, wherein the data communication network is at least one of a wireless data network and a cellular data network.

4. The system of claim 1, wherein the vehicle data further comprises at least one of vehicle mileage, vehicle body damage, vehicle glass damage, vehicle paint damage, vehicle interior damage, vehicle location.

5. The system of claim 1, wherein the user interface is at least one of a touch-screen, a voice recognition module, and a keyboard.

6. The system of claim 1, wherein the vehicle data further comprises at least one of a photograph and a video of the vehicle.

7. The system of claim 1, wherein the management console utilizes a third party service to generate a basic form of the vehicle trade in value report.

8. The system of claim 7, wherein the third party service includes at least one of kbb.com and edmunds.com.

9. A method for creating a vehicle trade in value report, the method comprising the steps of:
providing a data communication network;
providing a management console in communication with the data communication network; and
providing a mobile console in communication with the data communication network, the mobile console comprising:
a user interface for receiving input;
a display for presenting information;
a wireless communication interface for sending information to and receiving information from the data communication network;
a data reader;
a memory for storing the information that is sent and received and for storing operational instructions for the mobile console; and
a processor for controlling and for sending information to and receiving information from the user interface, the display, the wireless communication interface, the data reader, and the memory,
receiving through the data reader information in regard to a vehicle identification number (VIN) of the vehicle, and storing it with vehicle data,
receiving through the user interface information in regard to condition of the vehicle, and storing it with the vehicle data,
sending the vehicle data from the mobile console across the data communication network to the management console,
receiving from the management console across the data communication network at the mobile console the vehicle trade in value report, and
displaying the report on the display.

10. The method of claim 9, wherein the mobile console is smart phone or a tablet computer.

11. The method of claim 9, wherein the data communication network is at least one of a wireless data network and a cellular data network.

12. The method of claim 9, wherein the vehicle data further comprises at least one of vehicle mileage, vehicle body damage, vehicle glass damage, vehicle paint damage, vehicle interior damage, vehicle location.

13. The method of claim 9, wherein the vehicle data further comprises at least one of a photograph and a video of the vehicle.

14. The method of claim 9, wherein the management console utilizes a third party service to generate a basic form of the vehicle trade in value report.

15. The method of claim 14, wherein the third party service includes at least one of kbb.com and edmunds.com.

16. A method for creating a vehicle trade in value report, the method comprising the steps of:
providing a management console in communication with a data communication network;
accepting with the management console vehicle data from a customer computer, the vehicle data including,
a vehicle identification number (VIN) of the vehicle,
a condition of the vehicle, and
a mileage of the vehicle,
accepting with the management console customer data from the customer computer, the customer data including,
a customer name, and
a customer contact,
generating a vehicle trade in value report with the management console, and
sending the vehicle trade in value report from the management console to the customer computer.

17. The method of claim 16, wherein the vehicle data further comprises at least one of vehicle body damage, vehicle glass damage, vehicle paint damage, vehicle interior damage, vehicle location, a photograph of the vehicle, and a video of the vehicle.

18. The method of claim 16, wherein the management console utilizes a third party service to generate a basic form of the vehicle trade in value report.

19. The method of claim 18, wherein the third party service includes at least one of kbb.com and edmunds.com.
